(19) United States
(12) Patent Application Publication
(10) Pub. No.: US 2026/0203706 A1
(43) Pub. Date: Jul. 16, 2026

(54) Pictorial Inventory Management Using AI-Generated Digital Twins

(71) Applicants: Merrick Campbell, Monrovia, CA (US); Marc Campbell, Monrovia, CA (US); MaryJo Campbell, Monrovia, CA (US)

(72) Inventors: Merrick Campbell, Monrovia, CA (US); Marc Campbell, Monrovia, CA (US); MaryJo Campbell, Monrovia, CA (US)

(73) Assignees: Merrick Campbell, Monrovia, CA (US); Marc Campbell, Monrovia, CA (US); MaryJo Campbell, Monrovia, CA (US)

(21) Appl. No.: 19/021,197

(22) Filed: Jan. 15, 2025

(51) Int. Cl. G06Q 10/087; G06T 7/20; G06T 7/62; G06T 7/70; G06T 17/00

(52) U.S. Cl. CPC G06Q 10/087; G06T 7/20; G06T 7/62; G06T 7/70; G06T 17/00

(57) ABSTRACT

A system for visually cataloging physical items within a virtual catalog using AI-generated digital twins wherein a digital twin is a virtual proxy of a physical item. Each digital twin contains a visualization for the user to view and identify the item, a fingerprint to track the item as it enters and exits a physical storage location, a time record to estimate usage, and an optional label for the item. A method for automatically generating digital twins, including techniques for creating visual renderings and fingerprinting each item. This method further enables approaches to predict usage correlations and display information to users in an actionable manner. An apparatus containing the required computational hardware and optical image sensors to capture and process the data for the digital twin generation and system operation. The aforementioned system, method, and apparatus act as components of a consumer solution for visual inventory management.

### CROSS-REFERENCE TO RELATED APPLICATIONS

The present application claims priority to and the benefit under 35 U.S.C. § 119(e) of U.S. Provisional Ser. No. 63/621,553 filed on Jan. 16, 2024, entitled PICTORIAL INVENTORY MANAGEMENT USING AI-GENERATED DIGITAL TWINS.

### STATEMENT REGARDING FEDERALLY SPONSORED RESEARCH OR DEVELOPMENT

Not Applicable

### FIELD OF THE DISCLOSURE

The field of disclosure concerns a system, method, and apparatus for virtually cataloging household items contained within a physical storage location.

### BACKGROUND OF THE INVENTION

Household inventory management has historically been a manual task, falling onto one or more members of a household. Industry has developed several solutions for inventory management using a wide range of technologies including mobile applications, RFID tags, barcode scanners, and cameras. However, technologies such as barcodes and RFID tags, which are used to identify items and track them within an industrial inventory management system, may not work well in household situations. Even barcodes, which are nearly ubiquitous on packaged retailed items, may not work well in homes since not all users are inclined to scan barcodes at home. Thus, these active technologies which require manual input are not suitable for routine household use and household inventory management has focused on passive systems using cameras. The following disclosure introduces a new approach for camera based inventory management.

Cameras incorporated into automated inventory management systems can be grouped into two general approaches: see-the-shelf cameras and known-item classification cameras. The see-the-shelf camera approach generally uses one or more interior image sensors to provide a view of the shelves. This approach shows the items that are visible and not occluded by other items. The known-item camera approach generally uses some form of a neural network to classify items as they are placed onto the shelf using either an internal or external camera. This approach tracks items contained within the training dataset. Either approach may attempt to read package labels via optical character recognition (OCR).

The disclosed approach uses digital twins to represent items stored inside a physical storage location within a virtual, visual catalog. This system uses one or more camera devices with one or more optical image sensors to track the items that enter and exit a physical storage location. Instead of classifying the item to identify it, the system creates a digital twin with a user-viewable visualization that can be viewed within a digital catalog. The visualization of the digital twin is created by segmenting the scene to isolate the item in a person's hand and then filling in any missing pixels with an AI-enhanced inpainting technique. The resulting digital twin can be included in a visual catalog, which may be viewed with a software application or other graphical user interface. This digital twin approach isolates individual items and estimates occluded regions of items to provide visual information at-a-glance. This visual approach is not limited by the number of items contained within a neural network training dataset and works with unknown items. The system claimed herein builds upon this research in smart home consumer electronics, but moves in a new direction: using a camera device with a field of view that encompasses ingress/egress region of a control volume to track items and construct a visual representation of the storage location's contents.

### BRIEF SUMMARY OF THE INVENTION

A system to monitor the contents of a physical storage location that automatically generates a virtual representation of physical items, browsable by a user within a visual catalog is disclosed. The system stores the virtual representation within a digital twin construct. A digital twin contains a visualization for the user to view and identify the item, a fingerprint to track the item as it enters and exits a physical storage location, a time record to estimate usage, and an optional label to identify the item. The disclosed system works with both known and unknown items due to the disclosed method for generating the digital twins. When packaged as a consumer electronic device, this system enables consumers to monitor the contents of a storage location. This electronic device contains the required computational hardware and optical image sensors to capture and process the data for the digital twin generation and system operation. When packaged as a standalone device, users can place the device to monitor the contents of any household storage region with known boundary ingress/egress regions, such as a refrigerator, pantry, tool chest, or linen closet. In an alternate embodiment, the system may be integrated with an appliance (e.g., refrigerator) or household fixture (e.g., wardrobe).

### BRIEF DESCRIPTION OF THE DRAWINGS

FIGS. 1A-1E diagram possible configurations for placing one or more optical sensors relative to the ingress/egress regions of a physical storage location's control volume.

FIG. 2 compares a representation of an item in the physical world and the components of that item represented as a virtual digital twin.

FIGS. 3A and 3B depict the process for creating the digital twin.

FIG. 4 provides an overview of the process for creating the visualization component of a digital twin.

FIG. 5 diagrams the pixel-based and spatial-temporal attributes that compose the digital twin fingerprint.

FIG. 6 depicts possible approaches to interact with a catalog of digital twins and to view their visualizations.

FIG. 7 provides an overview of the system including the device containing the optical sensor(s), the digital twin, the datastore containing a catalog of digital twins, techniques for analyzing the catalog, and application to view the catalog.

FIGS. 8A-8C depict possible camera device configurations containing one or more optical sensors and system architectures for communicating with the datastore and application to view the digital twin catalog.

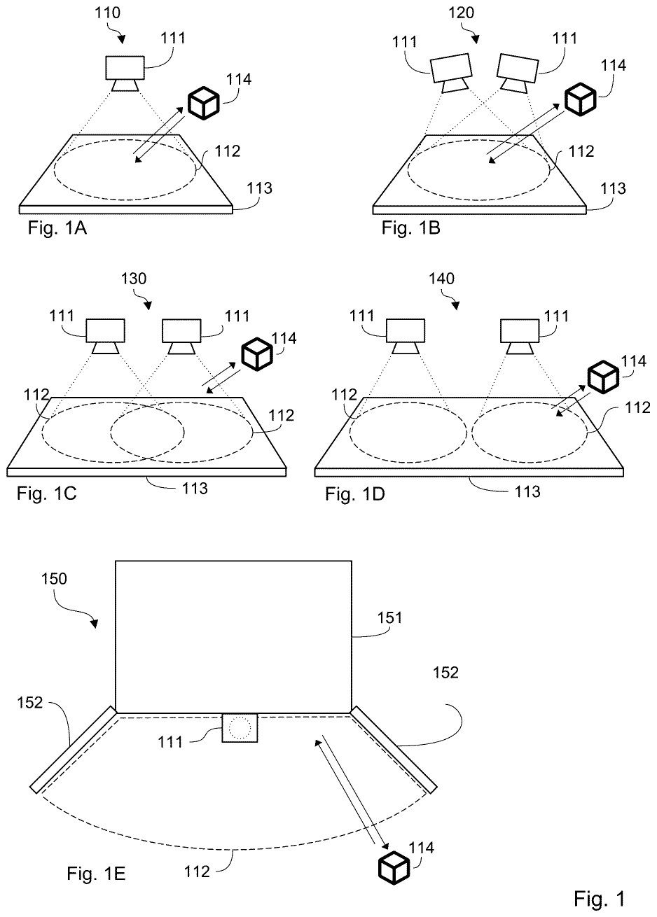

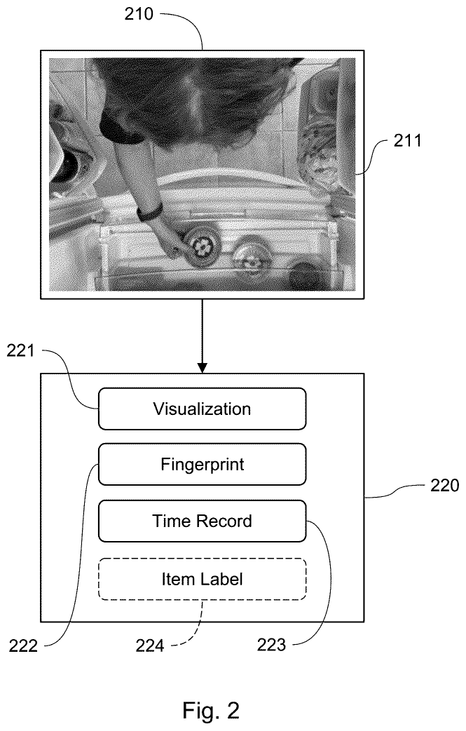

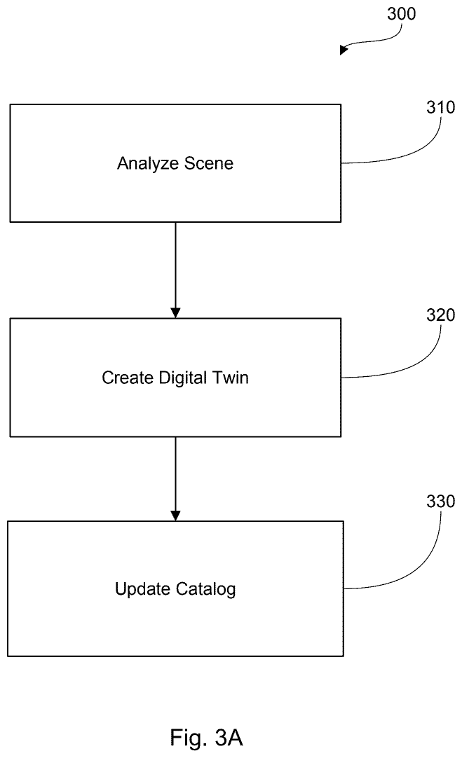

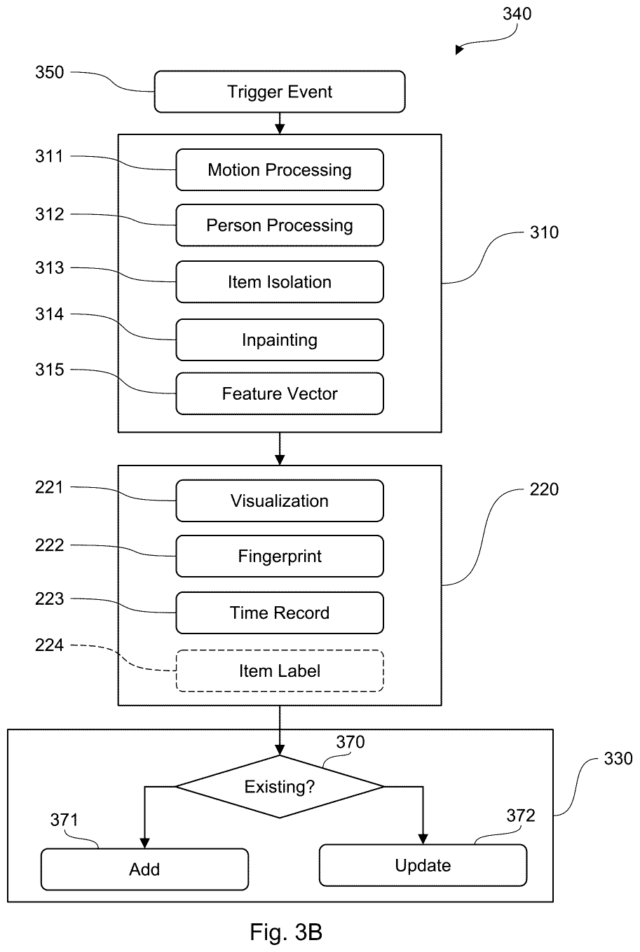

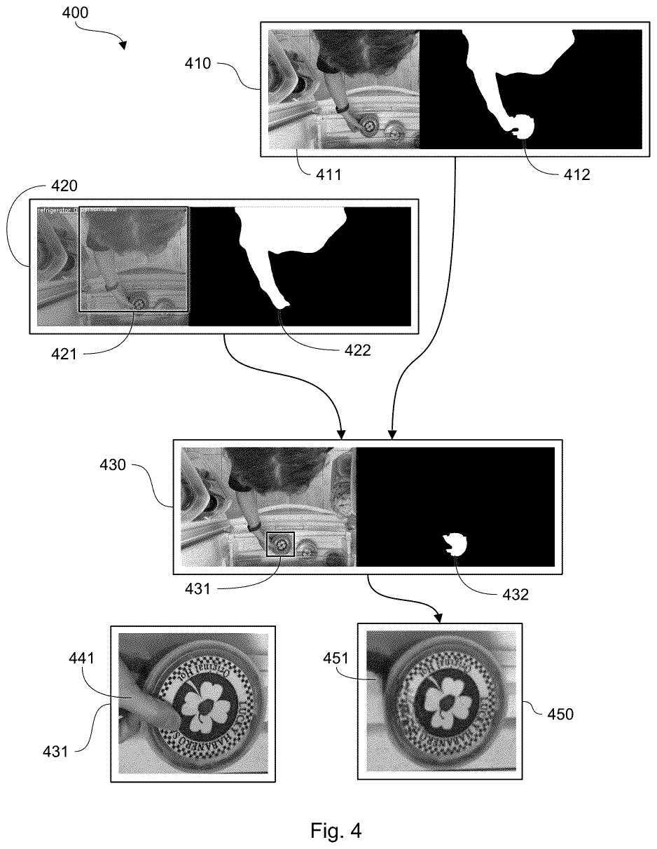

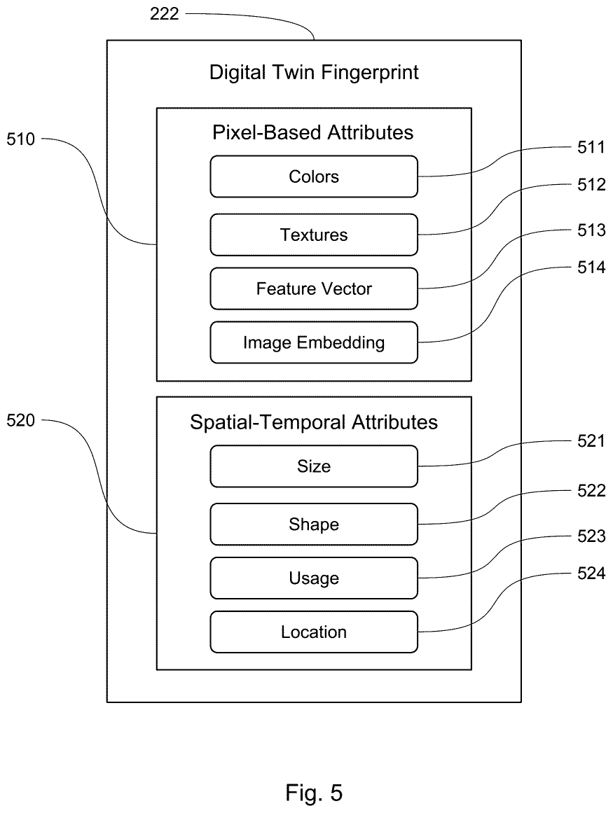

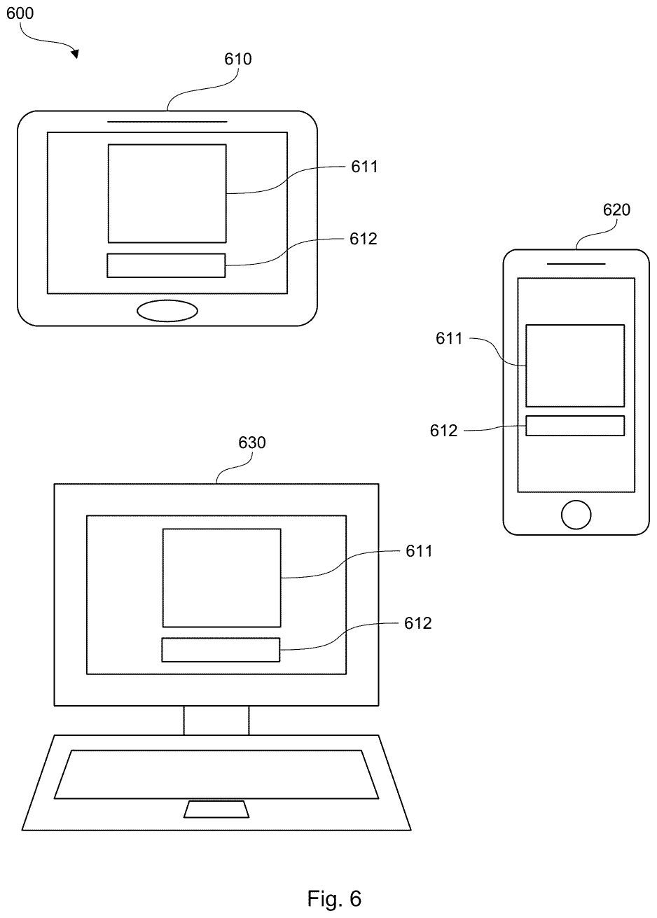

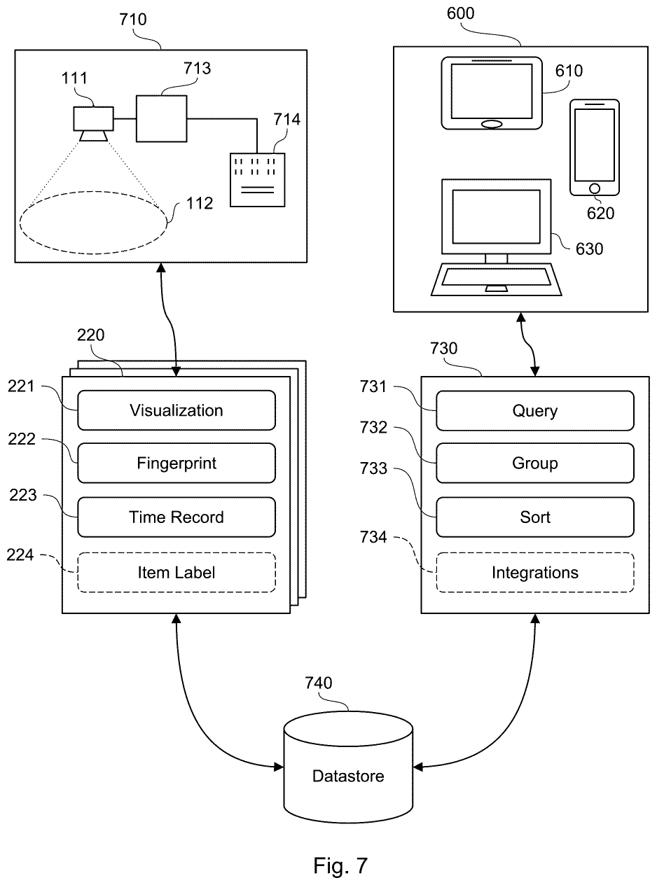

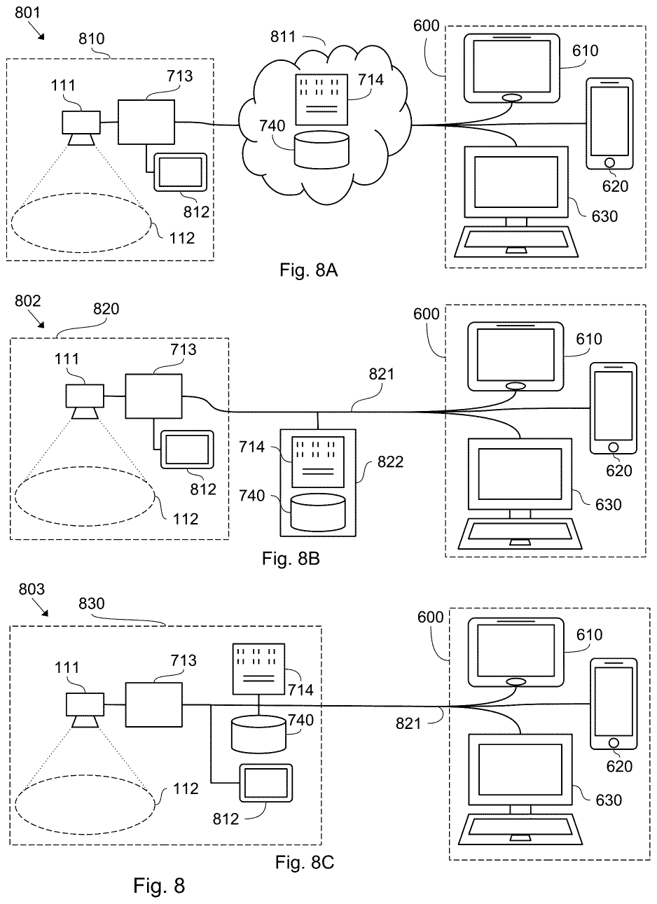

### DETAILED DESCRIPTION OF THE INVENTION

The system treats a household storage location, such as but not limited to a refrigerator, pantry, closet, cabinet, chest, or other appliance as a bounded control volume with one or more known boundary ingress/egress regions. A control volume is a fixed region with defined boundaries and at least one known ingress/egress region. One or more optical sensors 111 are positioned such that the sensor(s) field of view 112 can monitor the boundary ingress/egress region of the control volume. Conceptually, 113 is the image plane. Either a single optical sensor 110 or a stereo pair 120 may be used to monitor the ingress/egress region. In some cases 130, multiple sensors 111 with an overlapping field of view may be used 112 to cover a single ingress/egress region. In other cases 140, the control volume may have multiple ingress/egress regions that may be monitored by one or more optical sensors. In a non-exhaustive example configuration 150, the image sensors 111 are positioned above a double-doored 152 storage unit, such as a wardrobe, so that the field of view 112 encompasses all items 114 that enter and exit the interior 151 space. This interior space 151 represents the control volume in this example and the item 114 may be an article of clothing or a piece of jewelry. This control volume is not limited to wardrobes and a user may implement a system on many other control volumes with any number of doors or openings, as long as the ingress/egress region(s) are monitored. Some storage location configurations may have zero doors, one door, or any number of doors, drawers or shelves which fall under the image sensor(s) field of view 112.

A digital twin 220 represents a physical item 211 in the virtual world 210 and essentially comprises of: a visualization 221 of the item produced through a blend of classical computer vision and neural networks, a unique feature-vector fingerprint 222 to identify each item, a time-record 223 to log item entrances and exits from the control volume; and an item label 224. The label 224, which may be omitted from a digital twin entry 220, may be created manually or with a classification neural network. The label 224 may be omitted since the system does not rely upon classification for tracking items and updating an inventory. Instead, the unique feature-vector fingerprint 222 is used to track items and update a catalog of digital twins located within a datastore 740. The feature-vector fingerprint 222 is composed of unique pixel-based 510 and spatial-temporal 520 attributes that embed unique item characteristics.

The digital twin cataloging process 300 begins when an item crosses the ingress/egress region of the physical storage location's control volume. During the cataloging process 300, the system analyzes the scene 310, creates a digital twin 320, and updates a virtual catalog 330. The cataloging process 340 begins after a triggering event 350, which may include but is not limited to an opening door, motion detection, or person detection. During the scene analysis step 310, the computer software processes the optical sensor data and generates a feature vector 315 of the item(s) 114 crossing the boundary ingress/egress region. The components of the digital twin 220 are extracted from the analyzed data to create the digital twin 320. A digital twin may be stored 740 within a virtual catalog containing a collection of one or more digital twins. A catalog update step 330 is performed so that the virtual digital twin catalog reflects the physical items contained within the storage location. During the update step 330, the system checks the fingerprint 222 to determine if the item exists 370. The system either automatically creates a new digital twin entry within the virtual catalog 371 or updates existing item entries within the virtual catalog 372. The system may increment or decrement inventory count as appropriate, and correlate items with known, predicted, and estimated usage habits.

Scene analysis 310 contains several steps which include determining the items moving within the scene 311, identifying the person(s) within the scene 312, and isolating the object(s) 313 being manipulated by the person(s). Conceptually, the scene may be segmented broadly into several categories. Stationary infrastructure is comprised of the fixed parts of a storage location that encompasses the static scene and non-moving objects within the camera's field of view. Repeated path motion infrastructure is comprised of objects such as door(s), lid(s), and drawer(s) that move along a consistent path when opened and closed. Stationary product is comprised of products sitting within the storage location control volume, potentially outside the camera's field of view. Repeated path motion product is comprised of products sitting on regions such as shelves or drawers that are visible when the door or drawer is open. The stationary infrastructure, the repeated path motion infrastructure, the stationary product, and the repeated path motion product are analyzed to determine what is moving within the scene 311. The person in motion 312 may be moving an item into or out of the storage location. The key region of interest is the hand/product locality. The dynamic motion product is an item or items being moved by a person's hand. The dynamic motion product is what remains when all other segments are removed. The software masks out the person moving the items and isolates the dynamic motion item representing the item instance. This isolation 313 may be accomplished through a combination of classical computer vision techniques such as optical flow and modern neural networks.

The inpainting component 314 of the scene analysis 310 generates either two or three dimensional renders for the digital twin's visualization component 221. The two dimensional (2D) renders of the items may be created by analyzing an image sequence containing the item, masking occluded portions of the item, inpainting 314 occluded portions of the item, refining the item's boundaries; and replacing the item's background. Image inpainting 314 is the task of recreating missing pixels within an image, which may be accomplished through classical computer vision techniques or generative artificial intelligence. The three dimensional (3D) animations may be created by analyzing an image sequence containing the item, identifying known geometric features, estimating unknown geometric features, and reconstructing the item's geometry. The inpainting image pipeline 400 performs a step 410 to analyze an image frame 411 to mask 412 the moving objects within the scene. The image pipeline 400 also performs a step 420 to identify the person within the scene 421 and create a mask 422. The motion analysis 410 and person detection 420 steps are combined to isolate 430 the item of interest 431 and create another mask 432. The resulting item region of interest 431 contains a subregion that is occluded by the person's hand 441 manipulating the item. Artificial Intelligence based inpainting techniques 450 are used to fill in the blanks 451 left once the person's hand holding the object is masked out. The Artificial Intelligence takes the occluded image and reconstructs it to produce a visualization 221 for a digital twin 220 such that a user can easily identify the item from the image of the digital twin.

The feature vector 315 from the scene analysis 310 may be used to track items as they cross the boundary of the control volume through several steps which generally include determining each item's pose and motion vector, estimating each item's final position inside or outside the storage location, and fingerprinting 222 each item with a feature vector using pixel-based 510 and spatial-temporal motion attributes 520. Pixel-based attributes contain information on the item such as colors 511, textures 512, features 513, and image embedding 514. Spatial-temporal motion attributes contain information on how, when, and where an item moves and can be used to determine the size 521, shape 522, usage 523, and location 524 of an item. Tracking is comprised of detecting and matching steps. Detecting occurs when an item crosses the visual boundary as it is placed into or removed from the physical storage location. Matching occurs at this time by checking the digital twin fingerprint to determine if the item is a new 371 or returning 372 item.

The spatial-temporal 520 nature of the data gathered for segmentation is used to support instance tracking of items, which take advantage of three key observations. First, all items which are added to or removed from the storage location pass through the camera's field of view 112 encompassing the visual boundary monitoring region. Second, the percentage of items known to be in the storage location increase over time towards 100% coverage with a boundary monitoring region approach, even if the initial inventory is completely unknown. Third, each item placed into the storage location has a unique fingerprint 222 and an estimated placement location that can be used for matching item instances as they are added or removed. As items pass through the ingress/egress region of the control volume, each item's pose and trajectory may further enhance tracking and estimating where an item was placed. By tracking how an item crosses the visual boundary of the scene with respect to the known physical location storage location through this region, the software can determine whether the item was placed into or removed from the storage location. Depth information from the scene, which may come directly from a calibrated stereo sensor pair or determined from a monocular sensor, can further enhance estimating where an item was placed within the physical storage location. Matching an item involves comparing the fingerprint 222 and the approximate location between instances. This may be accomplished with classical computer vision metrics such as, but not limited to, template matching or advanced neural networks.

The digital twin visualization software application 600 allows users to interact with the virtual digital twin catalog through a graphical user interface and may be accessed on a tablet 610, mobile device 620, computer 630, or other display. The visualization software application may contain a viewport 611 to view and interact with item digital twin visualizations 221. The visualization software may also contain a region 612 to access any associated data or metadata such as the time record 223 or item label 224. The visualization software application 600 may contain tools for browsing a collection of digital twin renderings via user queries 731, automatically grouping the digital twins 732, and sorting the digital twins 733 as part of useful sets for supply level monitoring, inventory replenishment, task formulation, or other user arrangements. This software may automatically sort and group the items into several categories to be displayed. The visualization software application 600 may sort by ascending or descending time order from the longest to shortest time in the storage location. The app may also cluster the item visualizations 221 based upon certain groups. One item group may contain the items that were added most recently at a reoccurring rate. Another item group may be the cluster of items that have have been in the storage location the longest time. Both of these categories contain items that may need to be presented to the user in a useful way. Another possible category of items are those which are routinely removed and replaced. The item tracking algorithms enable filtering based on items most frequently or least frequently accessed. Users may also link or add metadata (e.g., text, photos, videos, urls) to each digital twin via this visualization application 600.

The system may be enhanced with capabilities for automatically grouping 732 and sorting 733 digital twins to gauge completeness of an item set, formulate an instruction set, and prompt user action. An item set is a group of items necessary to perform a task, such as the recipe ingredients necessary to cook a dish or the nuts, bolts, and hardware necessary to assemble a kit. An instruction set is the steps necessary to complete a task, such as cook a dish or assemble a kit. The system further contains capabilities for item life cycle monitoring that log the initial time an item is added to the inventory to determine if an item is a one-time or recurring entry with a replenishment window. Predicting the replenishment or expiration date may aid with integration into an external system 734. This data is also used to predict supply levels and estimate replenishment cycles. Several automatic features 730 may be available to the user such as, but not limited to grouping items 732, sorting items 733, and publishing alerts. These alerts may be tied to an order request system to replenish items 734.

The data for the system and software pipeline is collected from a camera device 710 containing one or more optical image sensor(s) 111 positioned such that the field of view 112 encompasses the boundary ingress/egress region(s) of a storage location. The camera's field of view enables tracking items moving through the boundary region of the storage location's control volume. The device's image sensor(s) record(s) while items are placed into and removed from the storage container. The optical sensor(s) 111 on the device may also be enhanced with special calibration to provide depth information. The camera device also contains an image sensor control and processing module 713. The camera device has access to a specialized processing module 714 and a datastore 740 for generating digital twins and storing them within a virtual catalog. The specialized processing module 714 may contain a graphics processing unit (GPU), tensor processing unit (TPU), neural processing unit (NPU), or other Artificial Intelligence enabling hardware. The device may further contain an item information management system using some form of type-ID such as bar code scanners or RFID tag readers. The device contains a user interface 812, which depending on the embodiment, may be as simple as an on/off switch or a more elaborate touch screen. The device architecture may be configured for a cloud-based system embodiment 810, a local network based system embodiment 820, or a self-contained embedded system embodiment 830.

The cloud-based system embodiment 801 utilizes a cloud-enabled camera device 810, cloud-based resources 811, and a visualization software application 600. The cloud-enabled camera device 810 includes one or more optical sensors 111 and the optical sensor control module 713. The cloud-enabled camera device 810 may also include a user interface 812. The cloud-based resources 811 provide the specialized processing module 714 and the datastore 740. The visualization software application 600 connects to the datastore 740 via an external network connection.

The local network-based system embodiment 802 utilizes a network-enabled camera device 820, network-based resources 822, and a visualization software application 600. The network-enabled camera device 820 includes one or more optical sensors 111 and the optical sensor control module 713. The network-enabled camera device 810 may also include a user interface 812. The network-based resources 822 provides the specialized processing module 714 and the datastore 740. The visualization software application 600 connects to the datastore 740 via a local network connection 821. The network communication 821 may occur over Ethernet, WiFi, Bluetooth, Zigbee, or other protocol.

The self-contained embodiment 803 utilizes a camera device 830 that includes one or more optical sensors 111, the image sensor control module 713, the specialized processing module 714 and the datastore 740. The visualization software application 600 may be part of the user interface 812 or accessed by a device over a network 821. The network communication 821 may occur over WiFi, Bluetooth, Zigbee, or other protocol. The user interface 812 may include a keyboard, touch screen, or other hardware.

These aforementioned device embodiments are non-exhaustive examples of apparatus configurations. In all embodiments, multiple devices may work with each other to provide complete coverage of the storage area's ingress/egress regions. The device may be a standalone unit as in the preferred embodiment or integrated within the storage location, container, or appliance constituting the control volume of interest in an alternate embodiment.

What is claimed is:

1. A system for creating, browsing, and updating a virtual, visual catalog of items contained within a physical storage location comprising of:
A physical storage location, such as a closet, pantry, cabinet, drawer, shelf, or appliance with a defined control volume and known boundary ingress/egress regions;
One or more optical sensors positioned to monitor the boundary ingress/egress region of the control volume;
One or more processors to analyze the data from the optical sensor(s);
Computer software to identify items crossing the boundary ingress/egress region and generating a visual representation for the item;
A digital twin construct of the item containing a visual representation of the item and distinguishing features from the optical data;
A virtual catalog containing a collection of one or more digital twins;
A matching functionality using digital twin fingerprints to update catalog contents;
A graphical user interface to view the cataloged items along with any associated metadata; and
Network connectivity to disseminate the catalog and its contents.

1. The system of claim 1, further comprising a digital twin construct to represent a physical item in the virtual catalog comprising of:
A visualization of the item produced through a blend of classical computer vision and neural networks;
A unique feature-vector fingerprint to identify each item;
A time-record to log item entrances and exits from the control volume; and
An item label created manually or with a classification neural network.

1. The system of claim 1, further comprising capabilities for querying the virtual catalog for digital twin fingerprint matches for:
Creating new item entries within the virtual catalog;
Updating existing item entries within the virtual catalog;
Incrementing or decrementing inventory count as appropriate; and
Correlating items with known, predicted, and estimated usage habits.

1. The system of claim 1, further comprising capabilities for grouping digital twins to:
Gauge completeness of item set;
Formulate an instruction set; and
Prompt user action.

1. The system of claim 1, further comprising capabilities for item life cycle monitoring that:
Logs the initial time an item is added to the inventory;
Determines if an item is a one-time or recurring entry with a replenishment window;
Predicts the replenishment or expiration date;
Predicts supply levels; and
Estimates replenishment cycles.

1. The system of claim 1, further comprising capabilities for interacting with the digital twins contained in a virtual catalog, comprising of:
A graphical user interface to browse a collection of digital twin visualizations;
Automatic sorting options to arrange the digital twins visualizations;
Automatic grouping options to display the digital twins as part of useful sets for supply level monitoring, inventory replenishment, or task formulation;
Settings to manually modifying an aforementioned group or sort;
Alerts to display timely information to users about the inventory;
An order request system to replenish items; and
Viewing access to from the web, desktop, mobile device, or other appliance.

1. The system of claim 1, further comprising capabilities for linking or adding to metadata (e.g., text, photos, videos, urls), comprising of:
A neural network to apply a text-based label or other metadata to a digital twin; and
A manual entry process to link metadata to a digital twin.

1. A method for visually cataloging the contents of a control volume with digital twins, the method comprising:
Monitoring the boundary ingress/egress region of the storage location's control volume with one or more cameras;
Processing the camera data with compute hardware;
Isolating items from the camera scene as they cross the boundary of the control volume;
Tracking items as they cross the control volume boundary;
Automatically generating a digital twin using the camera data for each item crossing the control volume boundary;
Matching digital twin fingerprints with existing catalog entries to update the virtual catalog;
Recording each new digital twin within a virtual catalog; and
Visualizing the digital twins using an AI-rendered depiction within a software application accessible from a desktop computer, mobile device, or other appliance.

1. A method of claim 8 for segmenting the camera scene, the method comprising:
Filtering static items within the scene;
Identifying the person(s) within the scene; and
Isolating the object(s) being manipulated by the person(s).

1. A method of claim 8 for tracking items as they cross the boundary of the control volume, the method comprising:
Determining each item's pose and motion vector;
Estimating each item's final position inside or outside the storage location; and
Fingerprinting each item with a feature vector using pixel data and spatial-temporal motion.

1. A method of claim 8 for automatically generating digital twins to represent a physical object in a virtual world, which may comprise:
Creating a visualization of the item produced through a blend of classical computer vision and neural networks;
Creating a unique feature-vector fingerprint to identify each item;
Creating a time-record to log item entrances and exits from the control volume; and
Creating an item label created manually or with a classification neural network.

1. A method of claim 8 for recording digital twins within a virtual catalog, the method comprising:
Matching item feature-vector fingerprints to determine if an item is a new or existing catalog entry;
Updating existing catalog entries; and
Adding new catalog entries;

1. A method of claim 8 for generating two dimensional (2D) renders of the items represented by the digital twins, the method comprising:
Analyzing an image sequence containing the item;
Masking occluded portions of the item;
Inpainting occluded portions of the item;
Refining the item's boundaries; and
Replacing the item's background;

1. A method of claim 8 for generating three dimensional (3D) animations of the items represented by the digital twins, the method comprising:
Analyzing an image sequence containing the item;
Identifying known geometric features;
Estimating unknown geometric features; and
Reconstructing the item's geometry using known and unknown feature data.

1. A method of claim 8 for interacting with the digital twins within a visual catalog via a software application, the method comprising:
Browsing a collection of digital twin renderings;
Automatically sorting the digital twins;
Automatically grouping the digital twins as part of useful sets for supply level monitoring, inventory replenishment, or task formulation;
Manually modifying an aforementioned group or sort;
Publishing alerts to display timely information to users about the inventory;
Replenishing items via an order or request system; and
Networking for multi-device access to view on the web, from a desktop, mobile device, or other appliance.

1. An apparatus for monitoring the control volume's boundary ingress/egress region comprising of:
One or more optical image sensor(s) positioned to view the boundary ingress/egress region(s) of a storage location;
Embedded compute hardware to process the image data and generate digital twins;
Local data storage for image data and a digital twin catalog;
Network connectivity; and
User interface.

1. The apparatus of claim 16, wherein the compute hardware is enhanced with specialized processing units (e.g., GPU, TPU, or NPU) for generating and matching digital twins.

1. The apparatus of claim 16, wherein the image data is enhanced with cameras calibrated to provide depth information.

1. The apparatus of claim 16, wherein the apparatus is integrated within the storage location, container, or appliance constituting the control volume of interest.

1. The apparatus of claim 16, further comprising an item information management system using some form of type-ID such as bar code scanners or RFID tag readers.
